(19) United States
(12) Patent Application Publication
(10) Pub. No.: US 2017/0290736 A1
(43) Pub. Date: Oct. 12, 2017

(54) Vibrating Therapeutic Apparel

(71) Applicant: VIBRATING THERAPEUTIC APPAREL LLC, Newark, DE (US)

(72) Inventor: Amira Idris, Woodbridge, VA (US)

(73) Assignee: VIBRATING THERAPEUTIC APPAREL LLC, Newark, DE (US)

(21) Appl. No.: 15/367,090

(22) Filed: Dec. 1, 2016

Related U.S. Application Data
(60) Provisional application No. 62/320,031, filed on Apr. 8, 2016.

(51) Int. Cl. A61H 23/02; A41D 1/00

(52) U.S. Cl. CPC A61H 23/02; A41D 1/005; A41D 2400/322; A41D 2500/10; A41D 2500/20; A61H 2201/5023; A61H 2205/12; A61H 2205/06; A61H 2205/10; A61H 2205/08

(57) ABSTRACT

A therapeutic apparel article is configured with a supple wearable fabric article that can be configured over limb or nub of an amputated limb. The therapeutic apparel article is configured with a plurality of nodes for detachably attaching vibrating devices thereto. In addition, a control unit having a power source may be detachably attached to the wearable fabric article. A conductive network may extend from the control unit and/or the power source to provide electrical power to the nodes and the vibrating devices attached. A user may attach vibrating devices to various nodes of the wearable fabric article as desired. In addition, the vibrating devices and the control unit can be detached from the wearable fabric article to enable the wearable fabric article to be washed.

### BACKGROUND OF THE INVENTION

### Field of the Invention

The invention is directed to therapeutic apparel having a vibrating device and particular to sleeves and socks configured to reduce phantom limb pain.

### Background

Amputees experience phantom limb pain (PLP), a painful sensation that seems to be coming from the amputated limb. The pain occurs soon after surgery and can manifest as a twisting, burning, itching or pressure sensation. This PLP can last for several second to minutes, to hours or even days. Phantom limb pain usually diminishes during the first six months after surgery but may continue to occur for years. Phantom limb pain may emanate from various locations on the nub.

There are a number of medications that can be used to treat PLP including, acetaminophen, opioids, antidepressants, anticonvulsants, beta-blockers, muscle relaxants. Many of these medications come with undesirable side effects however. Some non-medication treatments include acupuncture, massaging of the residual limb, transcutaneous electrical nerve stimulation (TENS), biofeedback and use of a shrinker. These non-medical treatment options require an amputee to go out of their way for treatment, stop their activities and plug in a device, for example.

In addition, amputees typically have a lot of sensitivity to contact from the amputation site that is uncomfortable. Patient have to go through desensitization procedures to slowly become comfortable with contact. These procedures include rubbing the amputation site with fabrics and progressively more abrasive materials.

There exists a need for a treatment device that can be used to treat phantom limb pain and improve the desensitization process that is quick and effective and that is portable. There also exists a need for a treatment device that enables a user to select the area for treatment.

### SUMMARY OF THE INVENTION

The invention is directed to a therapeutic apparel article comprising a wearable fabric article that may be a sock or a sleeve. The therapeutic apparel article comprises a plurality of nodes, wherein each node comprises a node attachment for detachable attaching a vibrating device. A user or wearer of an exemplary therapeutic apparel article may elect to attach one or more vibrating devices to the nodes as desired. In addition, in an exemplary embodiment, a control unit comprising a power source, such as a battery, is detachably attachable to the wearable fabric article. A conductive network may extend from the control unit and/or the power source to the nodes, for the delivery of electrical power to the vibrating devices, through the nodes. A control unit may comprise a user input feature for controlling the vibrating device function such as, powering the vibrating devices off/on, controlling the vibrating level or intensity, and/or controlling the vibrating frequency or mode, such as oscillating more, ramping mode, random mode and the like. A wearable article may be configured as a glove or any other article for donning on or over part of the body. In one embodiment, the wearable article is wrapped around or over part of the body to form a sleeve or sock.

In an exemplary embodiment, the wearable fabric article is a supple article that can be folded over upon itself without damage. A user of the therapeutic apparel article may detach the vibrating device and the control unit and wash the wearable fabric article without damage, for example. In this way, a user may wash the therapeutic apparel article after use. The wearable fabric article may be made from fabric, such as a knitted or woven fabric. In a preferred embodiment, the fabric is a seamless fabric, wherein there are no seams that might cause irritation to a wearer. An exemplary wearable fabric article may comprise one or more layers, such as one or more layers of fabric or a synthetic material such as foam, an elastomeric material and the like. A synthetic material may comprise an elastomeric material including, but not limited to elastomeric foam, such as urethane or silicone foam. An exemplary wearable article may provide some compression when fitted on or over a limb. The wearable article may be elastomeric, wherein it can be stretched and upon removal of a tensile load, return substantially to an original shape. For example, a sock or sleeve may stretch to extend over a nub or limb and provide a compressive force and when removed it may then shrink back and return to an original shape or dimension. In an exemplary embodiment, a wearable fabric article comprises an inner layer, an outer layer and a conductive network extending therebetween.

An exemplary conductive network comprises one or more electrical leads that extend along the wearable fabric article and carry electrical current from the power source to the nodes. A vibrating device can then be attached to the node to receive said power for operation. The electrical leads may be insulated electrical wires that are woven into a fabric or fabric layer or extend between layers of the wearable fabric article. In an exemplary embodiment, electrical leads of the conductive network extend between an inner layer and an outer layer of the wearable fabric article, such as between woven fabric layers, between a synthetic layer and a fabric layer, or two synthetic layers. In another exemplary embodiment, the conductive network or the electrical leads are interwoven with a fabric. The conductive network or electrical leads are connected electrically with the nodes to supply power to the detachable vibrating devices. A conductive network may comprise conductive fabric that is interwoven with the wearable article and may comprise two separate layers of conductive fabric that are separated by a non-conductive layer. One of the conductive fabric layers may provide electrical current to a node and the other conductive fabric layer may be an electrical return from the node to the power source.

A node for attachment of a vibrating device may be comprise any conventional detachable attachment mechanism including a snap or snaps wherein a mating snap on the vibrating device are configured to be pressed to and couple with the node snaps. In an exemplary embodiment, a node is a locking attachment node, requiring at least two separate motions to attach and lock the vibrating device to the node. For example, the vibrating device may require insertion and then rotation to lock the vibrating device to the node. In an exemplary embodiment, a node comprises an electrical supply portion and an electrical return portion and the vibrating device comprises an electrical supply and electrical return portions. In another embodiment, a node comprises a conductive patch, such as a conductive fabric. A node may comprise hook-and-loop fastener material and the vibrating device may comprise hook-and-loop fastener material for detachably attaching thereto. A hook-and-loop fastener material may comprise a conductive element or be an electrically conductive fabric.

A control unit may also be detachably attachable to the wearable fabric article. A control unit may comprise an interface for connecting to the wearable fabric article. The wearable fabric article may comprise a controller interface that is configured to receive the control unit interface. For example, a control unit may snap on to a matching snap or snaps or may comprise terminal that plug into a receptacle of the controller interface, for example. A power source configured with the control unit, such as a battery, may supply electrical power to the conductive network and the vibrating devices through the controller interface. A user may turn the vibrating devices on and off through a user interface of the control unit. A user may change the output of the vibrating devices through the user interface of the control unit. For example, a user may want to increase the vibration or change the frequency of vibration and may use the user interface to change these vibrating device outputs.

The summary of the invention is provided as a general introduction to some of the embodiments of the invention, and is not intended to be limiting. Additional example embodiments including variations and alternative configurations of the invention are provided herein.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows person with an amputated arm donning a therapeutic apparel article as described herein.

FIG. 2 shows an exemplary therapeutic apparel article having a control unit and a plurality of nodes and vibrating devices attached thereto.

FIG. 3 shows an exemplary therapeutic apparel article having a control unit, a conductive network extending from the control unit to the plurality of nodes and vibrating devices configured for attachment to said nodes.

FIG. 4 shows an exemplary therapeutic apparel article that is a sleeve having a conduit therethrough.

FIG. 5 show the exemplary therapeutic apparel article shown in FIG. 6 with the control unit detached from the interface to the control unit on the sleeve

FIG. 6 shows an exemplary locking attachment interface for a vibrating device.

FIG. 7 shows person donning a therapeutic apparel article sleeve on their leg.

FIG. 8 shows person donning a therapeutic apparel article sleeve on their arm.

FIG. 9 shows person donning a therapeutic apparel article sleeve on their torso.

FIG. 10 shows a cross-section view of an exemplary wearable fabric article having an outer fabric layer, an inner fabric layer and a conductive network therebetween.

FIG. 11 shows a cross-section view of an exemplary wearable fabric article having an electrical supply snap and an electrical return snap as a node.

FIG. 12 shows a cross-section view of an exemplary wearable fabric article having snaps as a node.

FIG. 13 shows an exemplary wearable fabric that is folded over with the inside surfaces facing parallel with each other.

### DETAILED DESCRIPTION OF THE ILLUSTRATED EMBODIMENTS

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

In cases where the present specification and a document incorporated by reference include conflicting and/or inconsistent disclosure, the present specification shall control.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications and improvements are within the scope of the present invention.

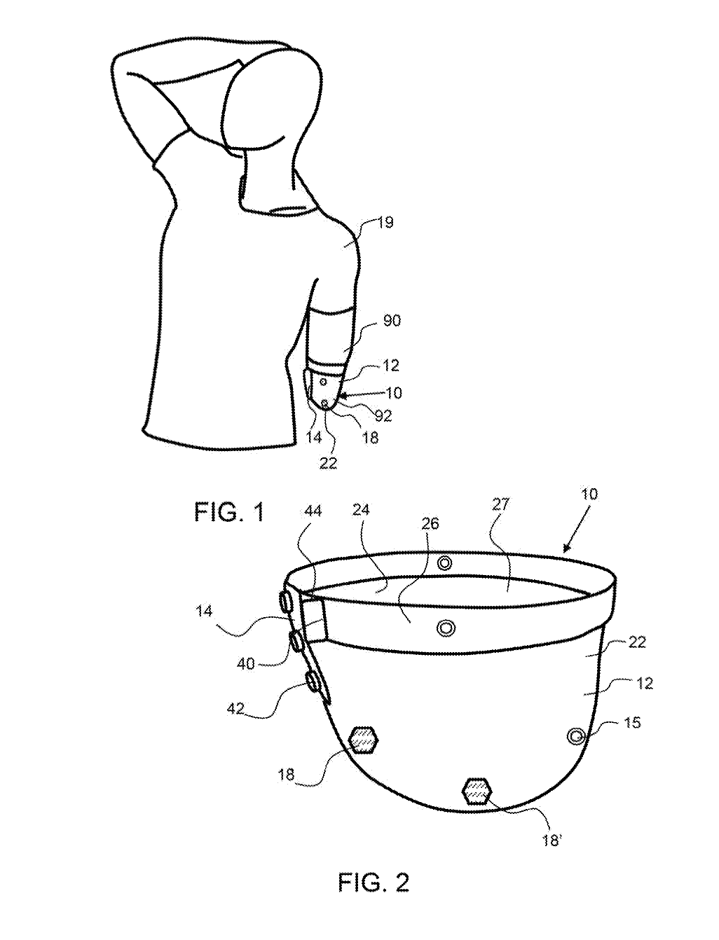

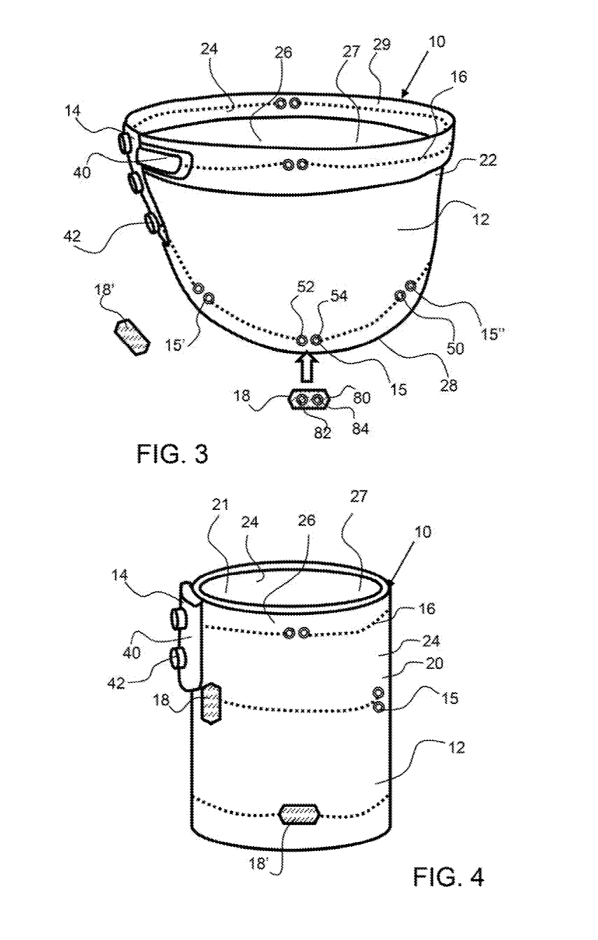

Referring to FIGS. 1 and 2, a person, or wearer 19, is donning an exemplary therapeutic apparel article 10 having a plurality of vibrating devices 18 attached thereto. The therapeutic apparel sock 22 is pulled up over the wearer's 19 amputated limb 92. A control unit 14 is also configured on the therapeutic article. The therapeutic apparel is a wearable article 12 in the form of a sock 22 that is pulled up over the amputated arm of the wearer. As shown in FIG. 2, the exemplary wearable fabric article 12 has an interior volume 27 for extending over the amputate limb. The wearable fabric article has an inside surface 24 and an outside surface 26. The plurality of vibrating devices 18, 18′ are attached to nodes 15 configured on the outside surface of the wearable fabric article. The vibrating devices 18 are detachably attachable to the nodes. The control unit 14 is also detachably attachable to the wearable fabric article and comprises a power source 40 and a user input feature 42. The control unit has an interface 44 that couples the control unit to the wearable fabric article 12 and to the conductive network, as shown in FIG. 3.

As shown in FIG. 3, a conductive network extends from the control unit and provides electrical power to the vibrating devices 18. The conductive neatwork extends to each of the nodes 15 and delivers electrical power to the vibrating devices 18 when they are attached to the nodes 15. The exemplary nodes shown in FIG. 3 comprise an electrical supply portion 52 and an electrical return portion 54 in the form of snaps 50. The vibrating device 18 is configured with a node interface 80 comprising an electrical supply portion 82 and an electrical return portion 84, configured to couple with the snaps. When the vibrating device is attached to the node, the electrical supply portion 52 and the electrical return portion 54 of the node couple with the electrical supply portion 82 and an electrical return portion 84 of the node interface 80 to complete a circuit with the power supply 40 and power the vibrating device. Again, the node and the node interface of the vibrating device may be snaps configured to snap together when pressed into each other to form a detachably attachable coupling. The therapeutic apparel article 10 of FIG. 3 is a sock having an open end 29 and a closed end 28 that forms an interior volume 27 for receiving a limb.

As shown in FIG. 4, the exemplary therapeutic apparel article 10 is a sleeve 20 having a conduit 21 therethrough. The sleeve may be pulled up over a limb with the inside surface 24 sliding up against a wearers limb. A sleeve type therapeutic apparel article 10 may be pulled over an arm, a leg, the torso and the like.

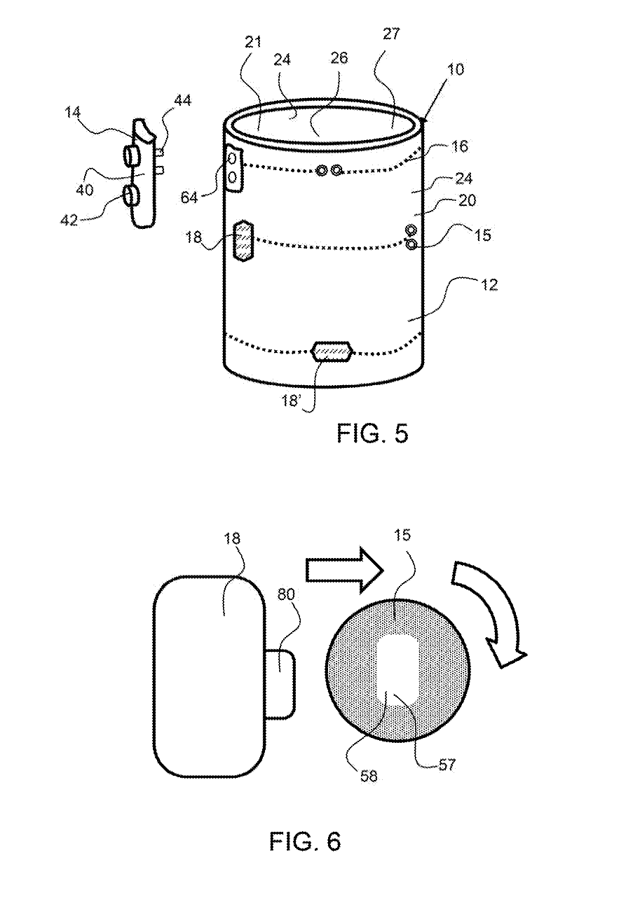

As shown in FIG. 5, the exemplary therapeutic apparel article 10 shown in FIG. 4 has the control unit 14 detached from the interface to the control unit 64 of the sleeve 20. The control unit has an interface 44 that is configured to couple the control unit and the power source 40 with the conductive network 16. With the control unit attached to the wearable fabric article 12, a supply of power from the power source can be delivered to the attached vibrating devices 18 through the conductive network 16 and the nodes 15. In addition, the control unit has user input features 42 that may change the power supply from the power source to the vibrating devices or may communicate with the vibration devices through the conductive network.

As shown in FIG. 6, an exemplary node 15 is configured with a locking feature 58 having a recess for receiving the node interface 80 of the vibrating device 18. The node interface is configured to extend into the recess and then when the vibrating device is turned or rotated with the node interface inserted into the recess, the vibrating device is locked to the node interface, whereby the vibrating device cannot be pulled from the node without first counter rotating the vibrating device.

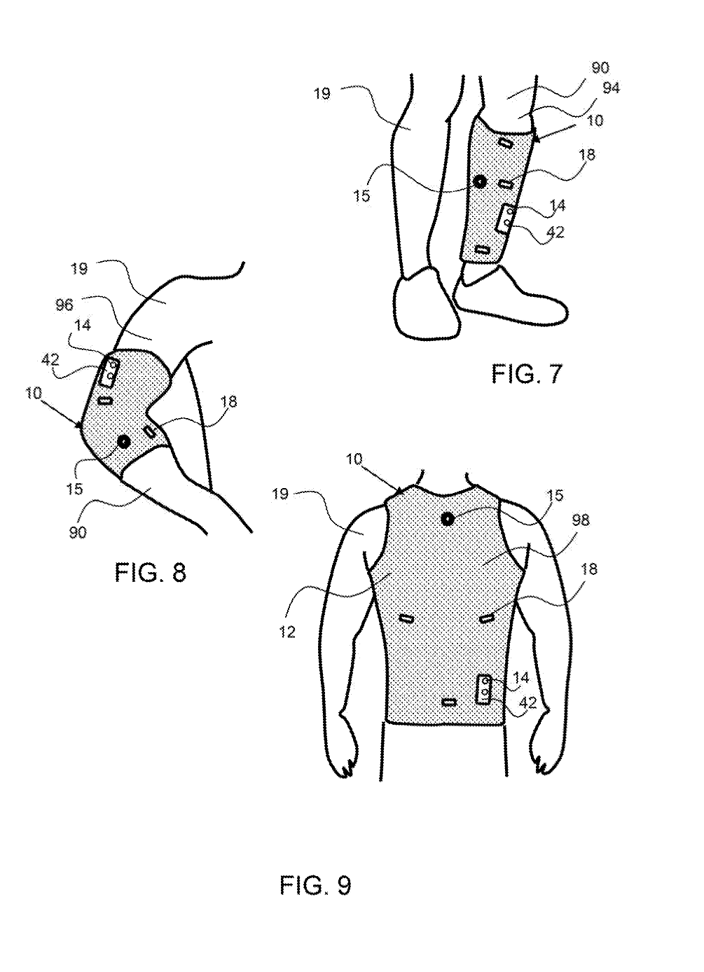

As shown in FIGS. 7 to 9, exemplary therapeutic apparel articles 10 are being worn by users. In FIG. 7, the exemplary therapeutic apparel article 10 is a sleeve 20 that is pulled up over a wearer's limb 90, their leg 94. In FIG. 8, the therapeutic apparel article 10 is configured on the wearer's arm 96 and in FIG. 9 the therapeutic apparel article 10 is configured around the wearer's torso 98

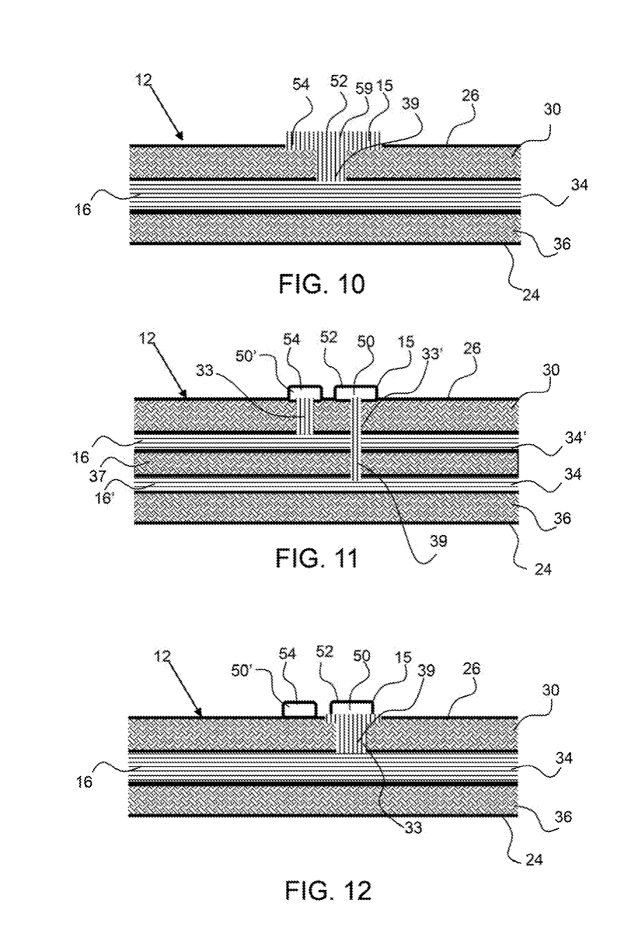

As shown in FIG. 10, an exemplary wearable fabric article 12 has an outer fabric layer 30, an inner fabric layer 36 and an interface layer 34 comprising a conductive network 16 therebetween. The outer fabric layer 30 extends to and forms part of the outside surface 26 of the wearable fabric article 12, and the inside fabric layer 26 extends to and forms part of the inside surface 24 of the wearable fabric article 12. The conductive network 16 provides a supply of power to the node 15 through a connection portion 39 from the conducive network and the node 15. The node has an electrical supply portion 52 and an electrical return portion 54. A node 15 may comprise an electrically conductive patch 59 that conducts electrical power from the conductive network.

As shown in FIG. 11, an exemplary wearable fabric article 12 has an electrical supply snap 52 and an electrical return snap 54 as part of a node 15. The connection portion 39 comprises electrical leads 33, 33′ from the conductive network 16. In this embodiment, the conductive network 16 comprises two separate interface layers 34, 34′, one for electrical supply and one for electrical return, respectively. A separator layer 37 extends between the two interface layers. The interface layers may be conductive fabric and/or electrical leads, such as insulated electrical wires that may be interwoven with the fabric.

As shown in 12, the exemplary wearable fabric article 12 has snaps 50 as a node. The electrical supply portion 52 is coupled electrically with the conductive network 16 by a connection portion 39, such as an electrical lead.

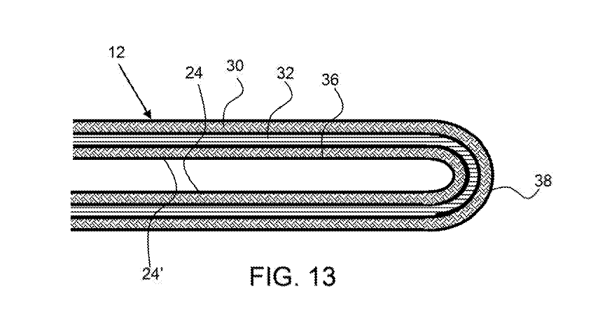

As shown in FIG. 13, the exemplary wearable fabric article 12 is folded over with the inside surfaces 24, 24′ extending parallel with each other. As described herein, an exemplary wearable fabric article is supple and may be folded over upon itself, with inside surface parallel and touching each other, and not be damaged.

A locking feature, as used herein, required two or more separate motions to detach the vibrating device from the attachment node, such as pushing in and rotating to lock to insert and counter rotating and pulling out to detach.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A therapeutic apparel article comprising:
a) a wearable fabric article comprising;
i) a plurality of nodes, wherein each node comprises a node attachment;
ii) a conductive network comprising electrically conductive leads that extend between and electrically connect the plurality of nodes to a power source;
b) a detachably attachable control unit comprising:
i) said power source;
ii) a user input feature;
iii) an interface to the conductive network:
c) a detachably attachable vibrating device having a node interface;
wherein the detachably attachable vibrating device is configured to detachably attach to one of said plurality of nodes to receive electrical power from the conductive network to provide a vibrating stimulation to a wearer of the therapeutic apparel article.

2. The therapeutic apparel article of claim 1, wherein the wearable fabric article is flexible and can be folded over without damage to the wearable fabric article.

3. The therapeutic apparel article of claim 2, wherein the wearable fabric article comprises a woven fabric.

4. The therapeutic apparel article of claim 2, wherein the wearable fabric article is a seamless knitted fabric.

5. The therapeutic apparel article of claim 2, wherein the wearable fabric article comprises a synthetic foam material.

6. The therapeutic apparel article of claim 2, wherein the wearable fabric is a sock having an interior volume.

7. The therapeutic apparel article of claim 2, wherein the wearable fabric is a sleeve having an interior conduit.

8. The therapeutic apparel article of claim 2, wherein the electrically conductive leads comprise insulated electrical wires that are integrated into the wearable fabric article.

9. The therapeutic apparel article of claim 2, wherein the wearable fabric article comprises:
a) an outer layer; and
b) an inner layer.

10. The therapeutic apparel article of claim 9, wherein the electrical wires are configured between the outer and inner layer.

11. The therapeutic apparel article of claim 1, wherein the node attachments comprise a snap.

12. The therapeutic apparel article of claim 11, wherein the node attachments comprise a first snap and second snap and wherein the first snap is an electrical supply snap and the second snap is an electrical return snap and wherein the first and second snaps are electrically coupled with the conductive network.

13. The therapeutic apparel article of claim 1, wherein the node attachments comprise a receptor for receiving the node interface.

14. The therapeutic apparel article of claim 13, wherein the receptor is a socket receptor.

15. The therapeutic apparel article of claim 13, wherein the node attachment comprises a locking feature, whereby the vibrating device is locked to the node attachment.

16. The therapeutic apparel article of claim 1, wherein the node attachment comprises a conductive fabric that is coupled with the conductive network to receive an electrical power from the power source.

17. The therapeutic apparel article of claim 1, wherein the user interface comprises a vibrating level input feature.

18. The therapeutic apparel article of claim 1, wherein the power source is a battery.

19. A therapeutic apparel article comprising:
a) a wearable fabric article comprising;
i) a plurality of nodes, wherein each node comprises a node attachment;
ii) a conductive network comprising insulated electrical wires that are integrated into the wearable fabric article and extend between and electrically connect the plurality of nodes to a power source;
wherein said power source is a battery;
b) a detachably attachable control unit comprising:
i) said power source;
ii) a user input feature;
iii) an interface to the conductive network:
c) a detachably attachable vibrating device having a node interface;
wherein the detachably attachable vibrating device is configured to detachably attach to one of said plurality of nodes to receive electrical power from the conductive network to provide a vibrating stimulation to a wearer of the therapeutic apparel article;
wherein the node attachments comprise a first snap and second snap and wherein the first snap is an electrical supply snap and the second snap is an electrical return snap and wherein the first and second snaps are electrically coupled with the conductive network;
wherein the wearable fabric article is flexible and can be folded over without damage to the wearable fabric article,
wherein the wearable fabric article is a sock of a sleeve having an interior volume for extending at least partially over a limb.

20. The therapeutic apparel article of claim 19, wherein the wearable fabric article comprises a woven fabric;
wherein the wearable fabric article comprises:
a) an outer layer; and
b) an inner layer;
wherein the electrical wires are configured between the outer and inner layer.
